(19) United States
(12) Patent Application Publication
(10) Pub. No.: US 2003/0117950 A1
(43) Pub. Date: Jun. 26, 2003

(54) Link redial for mesh protection

(76) Inventor: Gail G. Huang, Gloucester (CA)

Correspondence Address: SMART AND BIGGAR, 438 UNIVERSITY AVENUE, SUITE 1500 BOX 111, TORONTO, ON, M5G2K8, CA

(21) Appl. No.: 10/025,981

(22) Filed: Dec. 26, 2001

(51) Int. Cl. H04J 1/16

(52) U.S. Cl. 370/220

(57) ABSTRACT

Rather than finding an entirely new path to avoid a single failure of a path segment in an original path, a backup path is established at the time of the set up of the original path and, responsive to the single failure, the backup path is used to route traffic around the failed path segment. A number of working links that employ a given fiber between a head end node and a tail end node and require a gold level of protection may be logically considered a “working bundle”. A backup Label Switched Path (LSP) may be set up between the head end node and the tail end node to protect each of the working links in the working bundle such that, in the event of a failure in the fiber, each of the working links in the working bundle may be switched to a logical association of backup LSPs, i.e., a “backup bundle”.

### FIELD OF THE INVENTION

The present invention relates to protection of connections formed through a mesh-type communication network and, in particular, relates to a link redial protection scheme for such networks.

### BACKGROUND

Historically, telecommunications networks have been developed to serve constant bit rate voice traffic. Many telecommunications networks evolved to be circuit switched and based on Time Division Multiplexing. For optical networking in particular, the Synchronous Optical NETwork (SONET) architecture emerged as the preferred architecture in North America. Attributes, such as network resiliency, survivability and fast restoration of traffic using ring architectures, were seen as the main advantages of SONET over the alternatives. Increased traffic volume, brought about as a result of the popularity of the Internet, has arrived, coupled with a change in the character of traffic. The traffic on communication networks can now be largely packet-based, bursty and unpredictable.

Mesh networks are achieved when each node in a network is connected to every other node in the network. Full mesh networks may be expensive to deploy, but can yield an impressive amount of redundancy. In an alternative architecture, used in SONET, each node in the network is connected in a closed loop and the architecture is called a ring network. Ring networks are known for their ability to quickly switch traffic paths from a primary fiber to a redundant fiber in the event of a cut in the primary fiber. Although mesh networks may be seen to be more cost effective and easier to scale than ring networks, ring networks are more widely deployed and better known.

Where data in a ring network, using SONET, for instance, has a somewhat predetermined route (i.e., around a ring) from a source node to a destination node, there may be multiple routing possibilities for routing a packet through a mesh network. One routing protocol, that allows the determination of a path for a Protocol Data Unit (PDU, a generic name for a packet) to take through a network, is called Multi-Protocol Label Switching (MPLS). MPLS is a technology for managing network traffic flow. A path between a given source node and a destination node may be predetermined at the source node. The nodes along the predetermined path are then informed of the next node in the path by way of a message sent by the source node to each node in the predetermined path. Each node in the path associates a label with a mapping of output to the next node in the path. By including, at the source node, the label in each PDU sent to the destination node, time is saved at each node that would be otherwise needed for the node to determine the address of the next node to which to forward a PDU. The path arranged in this way is called a Label Switched Path (LSP). MPLS is called multi-protocol because it works with the Internet Protocol (IP), Asynchronous Transport Mode (ATM) and frame relay network protocols.

Using MPLS, two Label Switching Routers (LSRs) must agree on the meaning of the labels used to forward traffic between and through each other. This common understanding is achieved by using a set of procedures, called a label distribution protocol, by which a first LSR informs a second LSR of label bindings the first LSR has made. The MPLS architecture does not assume a specific label distribution protocol. In Loa Andersson, et al., LDP (Label Distribution Protocol) Specification, Internet Engineering Task Force (IETF), Internet Draft, draft-ietf-mpls-ldp-11.txt, August 2000, one such label distribution protocol, called LDP, is proposed. An LSR using LDP associates a Forwarding Equivalence Class (FEC) with each LSP the LSR creates. The FEC associated with a particular LSP identifies the PDUs which are “mapped” to the particular LSP. LSPs are extended through a network as each LSR “splices” incoming labels for a given FEC to outgoing labels assigned to outgoing links. All LDP messages have a common structure that uses a Type-Length-Value (TLV) encoding scheme. Further, some parameters included in LDP messages also use a TLV encoding scheme and are often referred to as TLVs.

In practice, a given LSR may receive a Connection Request message, that is, a request that a path be built from the given LSR to a specified destination LSR, for a stream of data to come. The given LSR determines a shortest path and sends an LDP message to each LSR along the determined shortest path to build a virtual path for the stream of data. PDUs in the stream of data include a label that, when read by a LSR, assists the selection of a link to the next LSR in the virtual path. The Connection Request message may indicate some constraints to be placed on the determination of the path. Routing that takes such constraints into account may be called Constraint-based Routing (CR) (see Bilel Jamoussi et al., “Constraint-Based LSP Setup using LDP”, IETF MPLS Working Group, Internet Draft, draft-ieff-mpls-crldp-05.txt, February 2001 and J. Ash et al., “LSP Modification Using CR-LDP”, IETF MPLS Working Group, Internet Draft, draft-ieff-mpis-crlsp-modify-03.txt, March, 2001).

Where the communication between nodes in a mesh network is optical and there may be many individual wavelength channels between two nodes, there is a requirement for routing protocols that treat the wavelength channels between these nodes appropriately. Recent advances have resulted in several proposed optical transport network specific routing protocols (see Yanhe Fan, et al., “Extensions to CR-LDP and RSVP-TE for Optical Path Set-up,” IETF MPLS Working Group, Internet Draft, draft-fan-mpis-lambda-signaling-00.txt, March 2000, Atsushi Iwata, et al., “Crankback Routing Extensions for CR-LDP”, IETF Network Working Group, Internet Draft, draft-fujita-mpis-crldp-crankback-01.txt, July 2000 and Fiffi Hellstrand et al., “Extensions to CR-LDP and RSVP-TE for setup of pre-established recovery tunnels”, IETF MPLS Working Group, Internet Draft, draft-hellstrand-mpls-recovery-merge-01.txt, November 2000).

Once a path is set up, in either a SONET ring network or an MPLS mesh network, it has been found to be of use to establish a method of protecting that path from network faults. Such faults include the inadvertent severing of one link in the path by, say, a construction crew.

Typically, each path between nodes in one direction around a SONET ring network is protected by second, backup path in the opposite direction around the SONET ring.

In contrast to the level of protection provided by SONET, a typical mesh network provides a “path redial” protection scheme. That is, the call setup process for a connection is automatically re-initiated in the event of a failure. More particularly, when a fault is discovered in a single link between two nodes along a path between a source and a destination, the source node of the connection using the path determines an alternate path through the network and switches the traffic that was using the connection to the alternate path. The alternate path is chosen to avoid use of the faulty link.

When considering the granularity of choice of protection schemes that a network service provider may offer to customers, the SONET 1:1 protection scheme may be considered to be the best, though at a cost. The path redial protection scheme may be seen to be less desirable, as there are circumstances where a backup path may not be available and the time required to determine a backup path may be significant when compared to the SONET protection scheme. In summary then, the SONET 1:1 protection scheme may be considered to be a “platinum” level of protection service, the path redial protection scheme may be considered to be a “silver” level of protection service and no protection at all may be considered to be a “bronze” level of protection. It would then be in the best interest of network service providers if there were a “gold” level of protection service that could be offered to customers.

When considering the qualities of such a “gold” level of service protection, it would be preferable to have a faster switching time than path redial and better use of the reserved protection bandwidth than SONET. It would also be desirable that the “gold” level of service protection is interoperable with LDP and/or CR-LDP protocols.

The “gold” level of service protection should have support for maintenance switching, i.e., switching to avoid a node taken out of service for planned maintenance. For support by this “gold” level of service protection, the maintenance switching should be deterministic and independent of maintenance elsewhere in the network. That is, the route that any working traffic will take around a node taken out of service for planned maintenance should be known ahead of time so as to avoid maintenance taking place at other nodes.

The “gold” level of service protection should also have an ability to protect any single link failure. Additionally, the “gold” level of service protection should be arranged such that the network size is not limited by the signaling channel bandwidth. For example, the use of bytes K1 and K2 in the line overhead for automatic protection switching in SONET is known to limit the size of SONET rings to 16 nodes.

### SUMMARY

A “gold” level of protection is provided for connections through mesh networks. Rather than redial each path affected by a fault on a single fiber used by those paths, the connections using the faulty fiber may be routed through one or more backup bundles, where bandwidth has been reserved expressly for that purpose.

In accordance with an aspect of the present invention there is provided a method of providing a link-redial service. The method includes receiving a request to set up a label switched path segment over a direct connection between a head end node and a tail end node, the request specifying a required protection bandwidth for the label switched path segment and determining a backup route to the tail end node, responsive to the receiving, where the backup route avoids use of the direct connection between the head end node and the tail end node. The method also includes signaling to reserve the required protection bandwidth along the backup route, receiving confirmation of reservation of the required protection bandwidth and generating a backup connection map, where the backup connection map associates a label related to the label switched path segment with an initial link in the backup route. In a further aspect of the present invention, there is provided a software medium that permits a general purpose computer to carry out this method.

In accordance with an aspect of the present invention there is provided a head end node in a mesh network. The head end node includes a plurality of input ports, a plurality of output ports, and a connection processor adapted to connect selected ones of the plurality of input ports to selected ones of the plurality of output ports according to a working connection map. The connection processor is operable to receive a request to set up a label switched path segment over a direct connection between the head end node and a tail end node, the request specifying a required protection bandwidth for the label switched path segment, determine a backup route to the tail end node, responsive to the receiving, where the backup route avoids use of the direct connection between the head end node and the tail end node, signal to reserve the required protection bandwidth along the backup route, receive confirmation of reservation of the required protection bandwidth and generate a backup connection map, where the backup connection map associates a label related to the label switched path segment with an initial link in the backup route.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 schematically illustrates a communication network for use with an embodiment of the present invention;

FIG. 2 illustrates steps performed by a head end node in a link redial protection reservation method according to an embodiment of the present invention;

FIG. 3 illustrates steps performed by a node in a backup route in a link redial protection reservation method according to an embodiment of the present invention;

FIG. 4 illustrates steps performed by a head end node in response to received messages according to an embodiment of the present invention;

FIG. 5 illustrates steps performed by a head end node in a link redial method according to an embodiment of the present invention;

FIG. 6 illustrates steps performed by a node in a backup route in a link redial method according to an embodiment of the present invention;

FIG. 7 illustrates steps performed by a head end node in a link recovery method according to an embodiment of the present invention; and

FIG. 8 illustrates an exemplary node for use according to an embodiment of the present invention.

### DETAILED DESCRIPTION

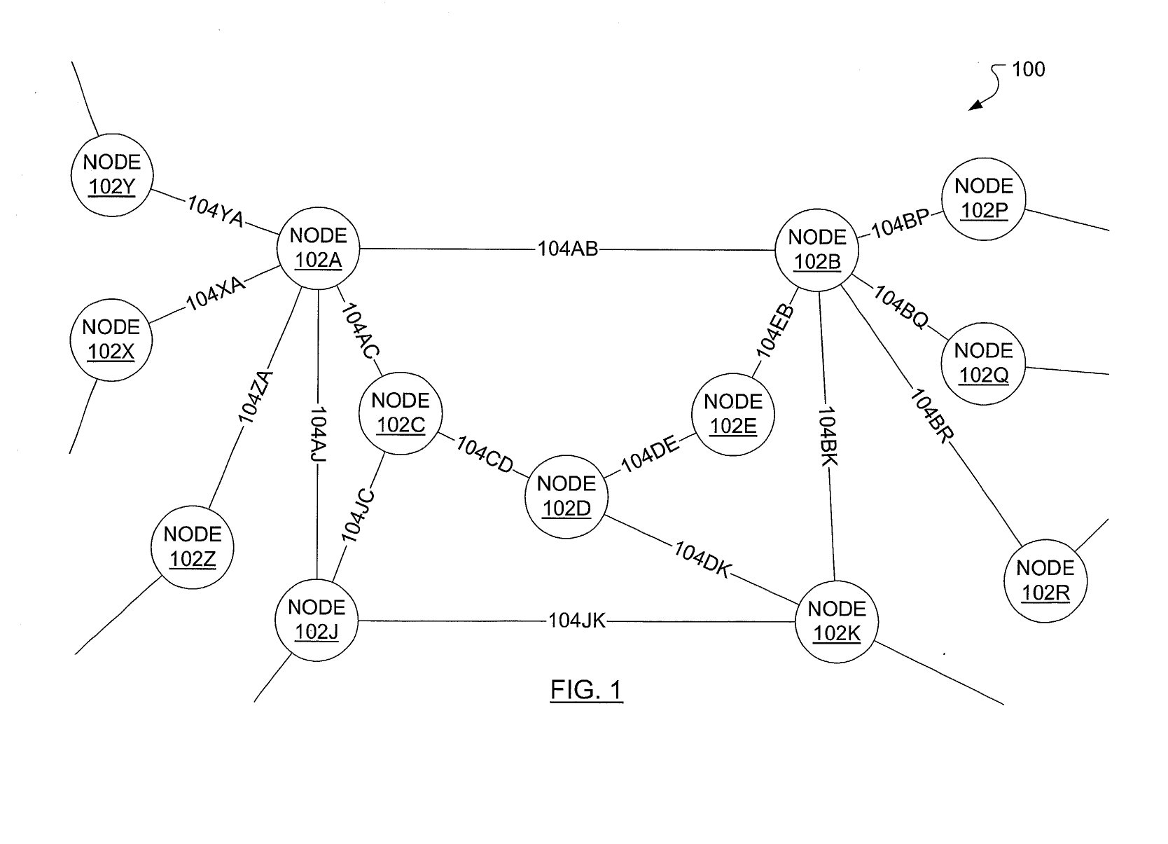

FIG. 1 illustrates an exemplary communication network 100 that is a mesh-type network of nodes 102A, 102B, 102C, 102D, 102E, 102J, 102K, 102P, 102Q, 102R, 102X, 102Y and 102Z (collectively and individually referred to herein as 102) connected to each other by fibers 104YA, 104XA, 104ZA, 104AC, 104JC, 104CD, 104AB, 104DE, 104JK, 104DK, 104EB, 104BP, 104BQ, 104BR (collectively and individually referred to herein as 104). Note that, although the fibers 104 have been called fibers for the purposes of this disclosure, the fibers 104 may, in fact, be any one of several transmission media including Ethernet cable and coaxial cable. Indeed, that which is identified as a single virtual fiber 104 may, in fact, be representative of multiple physical fibers.

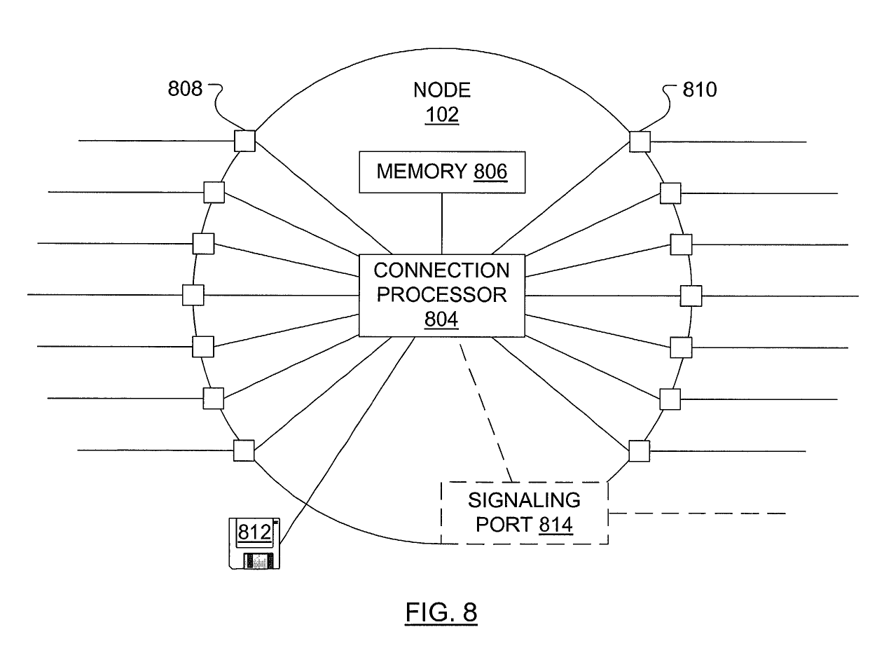

FIG. 8 illustrates an exemplary node 102 such as would be used in the exemplary communication network 100 of FIG. 1. The exemplary node 102 includes a connection processor 804 that is used to connect selected ones of a set of input ports 808 to selected ones of a set of output ports 810 according to a connection map that is stored in a memory 806. The connection processor 804 may be loaded with link redial mesh protection software for executing methods exemplary of this invention from a software medium 812 which could be a disk, a tape, a chip or a random access memory containing a file downloaded from a remote source. The exemplary node 102 may also include a signaling port 814 for sending and receiving out-of-band signaling related to the routing of traffic to other nodes 102.

To create a label switched path (LSP), a source node determines a route for the LSP and sends a Connection Request message to each node along the determined route. In fact, a single Connection Request message is sent, which indicates the determined route and allows a node along that route to act on the Connection Request message (i.e., establish a link to the next node in the indicated route) and forward the Connection Request message to the next node in the indicated route. Establishing a link to the next node in the indicated route may, for instance, involve reserving a particular unidirectional wavelength on a fiber between nodes in a Dense Wavelength Division Multiplexing system and recording that reservation in a “connection map”. In the future, when a PDU including a label associated with the LSP arrives at a node along the LSP, the node consults the connection map to determine where next to send the PDU. Once traffic is flowing over the LSP, the established link can be called a working link.

The link establishing process may be repeated multiple times for LSPs between other source nodes and destination nodes. For a given direct connection between a head end node and a tail end node, there may be multiple working links, each associated with a different LSP. Each working link may have been established according to different protection requirements.

In overview, a number of working links that (a) employ a given fiber between a head end node 102A and a tail end node 102B and (b) require a gold level of protection may be logically considered a “working bundle”. This bundling is possible even though each of the connections to which the working links relate may have widely distributed source nodes and destination nodes. A backup LSP may be set up between the head end node 102A and the tail end node 102B to protect each of the working links in the working bundle such that, in the event of a failure in the fiber, each of the working links in the working bundle may be switched to corresponding individual backup LSPs, i.e., a backup bundle.

Consider the fiber 104AB having the head end node 102A and the tail end node 102B. A first Connection Request message may be received at the head end node 102A indicating a preferred level of protection (platinum, gold, silver or bronze). The first Connection Request message may be for setting up a connection between a source node 102Y and a destination node 102P. Where the preferred level of protection is gold, a preferred amount of backup bandwidth may also be indicated. Responsive to the first Connection Request message, the head end node 102A establishes a first link over the fiber 104AB to the tail end node 102B using typical LDP signaling. Once this first link is established, the working connection map at the head end node may be updated to include the label related to the Connection Request message associated with an indication of the fiber 104AB to the tail end node 102B.

Additionally, the head end node 102A determines a backup route (say, through nodes 102C, 102D, 102E) and signals to the first node 102C along the backup route a description of the determined backup route and a desire to reserve the preferred amount of backup bandwidth along the backup route, i.e., establish a first backup LSP. Each node (102C, 102D, 102E) along the backup route receives signaling requesting this preferred amount of backup bandwidth and either reserves the appropriate bandwidth or determines that the preferred amount of backup bandwidth is unavailable and signals such back to the head end node 102A. Where the backup bandwidth reservation signaling reaches the tail end node 102B, the tail end node 102B can signal to the head end node 102A that a backup route has been reserved. Once this backup route is established, a backup connection map at the head end node may be generated or updated to include the label related to the Connection Request message associated with an indication of the fiber 104AC to the first node 102C in the backup route.

In the event of a failure in the fiber 104AB connecting the head end node 102A to the tail end node 102B, the traffic using the first link over the fiber 104AB may be switched to the backup route. This switching may be accomplished by replacing, at the head end node 102A, the working connection map with the backup connection map.

Where a second Connection Request message is received by the head end node 102A for a second link to the tail end node 102B and indicates the gold level of protection, a second link may be established over the fiber 104AB to the tail end node 102B. This second Connection Request message may be for setting up a connection between a source node 102X and a destination node 102Q. If the second link employs the same physical fiber, the same backup route may be employed, however further bandwidth would be necessarily reserved on a second backup LSP. The first working link and the second working link to the tail end node 102B, as they share a backup route, may then be logically associated with each other in what may be called a working bundle, where the first backup LSP and the second backup LSP may be logically associated with each other in what may be called a backup bundle.

Where a third Connection Request message is received by the head end node 102A for a third link to the tail end node 102B and indicates the gold level of protection, a third link may be established over the fiber 104AB to the tail end node 102B. This third Connection Request message may be for setting up a connection between a source node 102Z and a destination node 102R. If the third link employs the same physical fiber, the same backup route may be employed, however further bandwidth would be necessarily reserved on a third backup LSP. Consider a scenario wherein the head end node 102A unsuccessfully attempts to reserve further bandwidth on the previously established backup route (through nodes 102C, 102D and 102E). The head end node 102A may instead set up a backup LSP through nodes 102J and 102K. Further working links may be logically associated with the third working link on this backup route to form a second backup bundle.

Additionally, a working bundle using the fiber 104JK between a second head end node 102J and a second tail end node 102K, may set up a backup LSP through nodes 102C and 102D.

As will be apparent to a person skilled in the art, more than one backup bundle may be set up for each working bundle, so that an alternate backup route is available in the event that the bandwidth in one of the fibers is in use in the backup route of a primary backup bundle. A distinct backup connection map may be associated with each backup bundle.

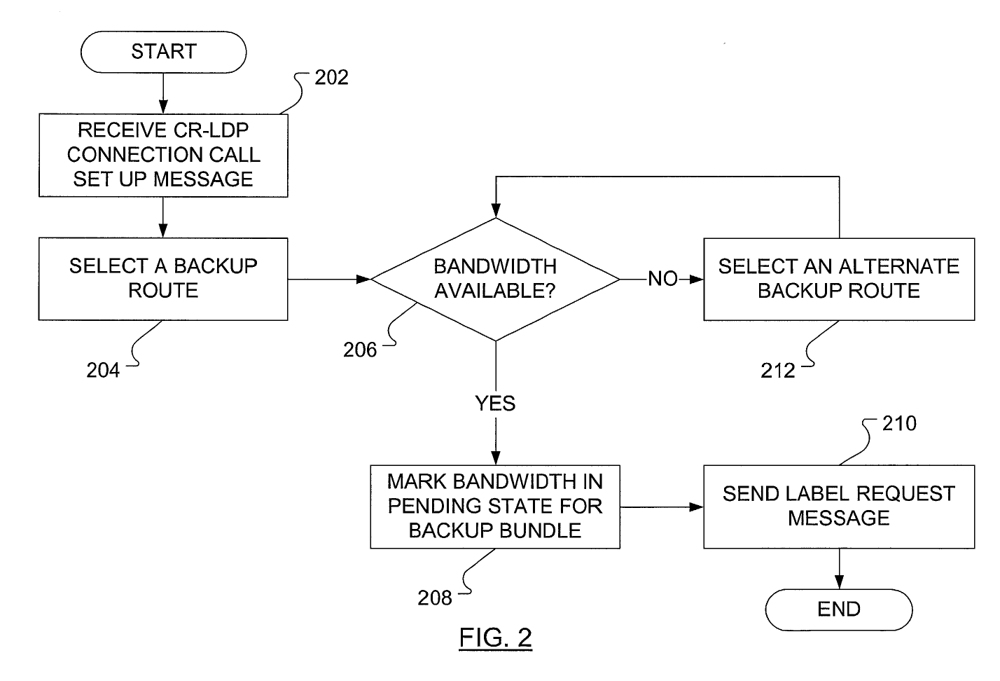

The steps required to reserve link redial protection bandwidth (the herein proposed gold level of protection), i.e., reserve a backup LSP, are illustrated in FIG. 2. Where a label switched path is being set up using constraint-based routing through the exemplary communication network 100 (FIG. 1), a typical CR-LDP Connection Call Setup message may be received (step 202) by the head end node 102A of the fiber 104AB. In addition to the CR-LDP signaling for setting up a working link over the fiber 104AB, there may be a requirement to reserve link redial protection bandwidth. Initially, the head end node 102A selects a backup route (step 204). The backup route may, for instance, be selected from a table of routes that have been pre-computed to connect the head end node 102A to the tail end node 102B. The routes in the table may be organized to reflect certain characteristics of the route that may be optimized when selecting a route. As such, a table of routes may be organized by a metric called “cost”, in which case the table may be called a Minimum Cost Route (MCR) table. The MCR table can maintain a list of a limited number of backup routes for a given link. The MCR table can also keep track of protection bandwidth availability status for each link on a backup route. Alternatively, a backup route can be determined instantaneously by the head end node 102A given information about the current state of the network 100.

Once a backup route has been selected, the head end node 102A may begin signaling to the first node 102C along the backup route to determine (step 206) whether the requested amount of protection bandwidth is available on the fiber 104AC between the head end node 102A and the first node 102C along the backup route. Notably, the amount of protection bandwidth required by the Connection Request message may be less than the amount of bandwidth requested for the link between the head end node 102A and the tail end node 102B. Where the requested amount of protection bandwidth is determined to be available, the head end node 102A may mark the state of that bandwidth as “pending” (step 208). Such marking of protection bandwidth may also be called reserving. The head end node 102A then sends a Label Request message (step 210) to the first node 102C along the backup route to reserve the protection bandwidth along the backup route. The Label Request message has been defined in the “LDP Specification” and modified in “Constraint-Based LSP Setup using LDP”, both documents being referenced above. For use in the present link redial scheme, the Label Request message requires further modification. Specifically, the Label Request message optionally includes the following enhancements:

The Label Request message may include a Type-Length-Value parameter that includes a unique identification (ID) of a Label Switched Path (LSP). Such a parameter may be called a “Backup LSPID TLV” and may be used to identify the backup LSP.

The Label Request message may include a “Merging LSPID TLV” that indicates the LSPID of the original connection. This enables the tail end node 102B to switch the traffic arriving on the last link in the backup route to the next node in the original connection.

The Label Request message may include a “Backup Bundle ID”.

Where the requested amount of protection bandwidth is determined (step 206) to be unavailable, the head end node 102A may select an alternate backup route (step 212) and determine (step 206) whether the requested amount of protection bandwidth is available on the first fiber 104 in the alternate route.

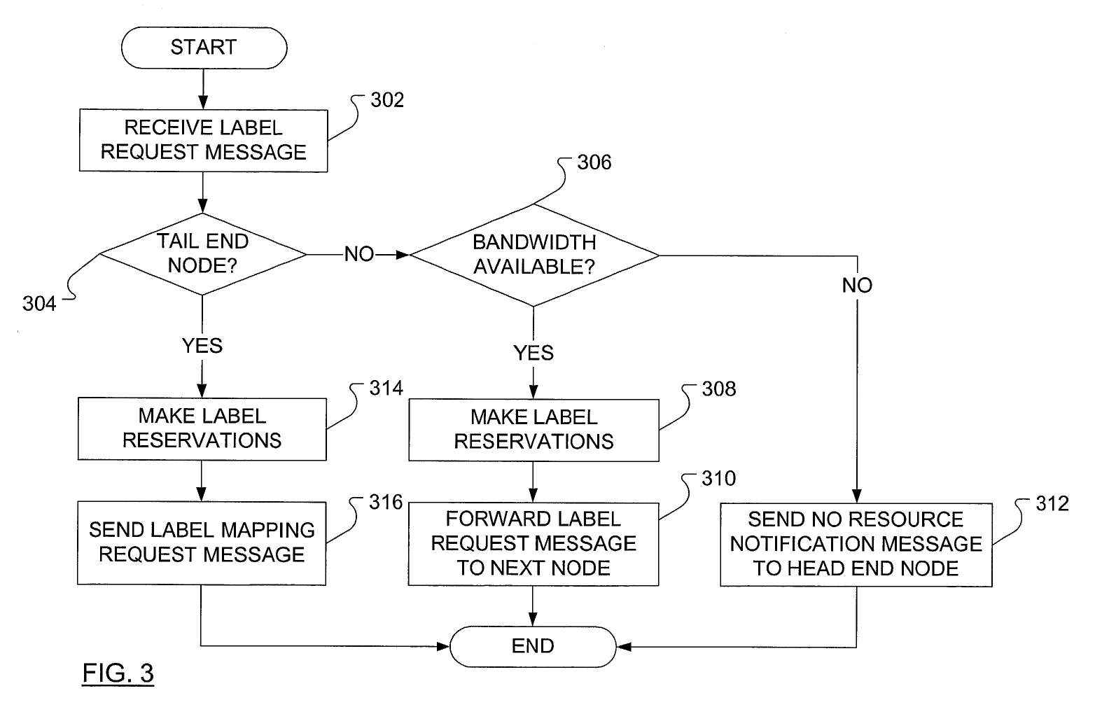

Steps followed by a given node on the backup route (e.g., the first node 102C) upon receipt of a Label Request message (step 302) are illustrated in FIG. 3. If the given node is not the tail end node 102B (step 304), the given node determines whether the amount of protection bandwidth requested in the Label Request message is available on a fiber 104 to the next node (step 306). If the protection bandwidth is determined to be available the given node makes the appropriate label reservations (step 308) and forwards the Label Request message to the next node in the backup route (step 310). If the protection bandwidth is determined not to be available the given node sends a No Resource Notification message to the head end node 102A (step 312). If the given node is the tail end node 102B (step 304), the tail end node 102B makes the appropriate label reservations (step 314) and sends a Label Mapping Request message (step 316) back along the backup route to establish the label assignment for the backup route. This Label Mapping Request message is processed by each node in the backup route back to the head end node 102A. The label mapping behavior occurs much the same as defined in the LDP/CRLDP specifications, except the label assignment is recorded in a backup connection map rather than the working connection map.

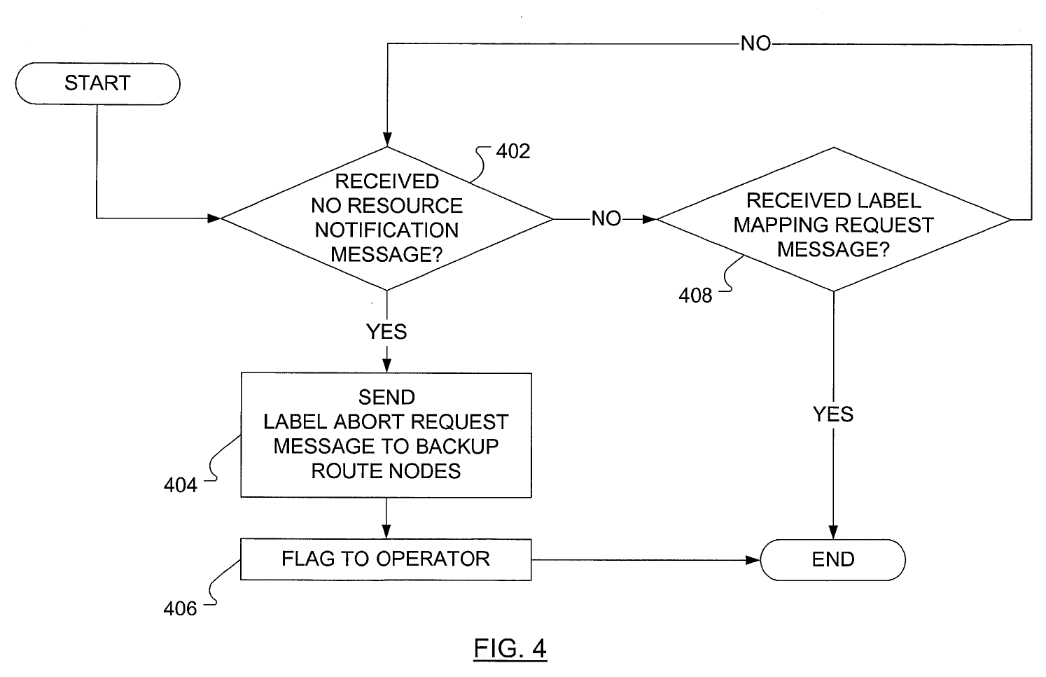

After sending the Label Request message (step 210, FIG. 2), the head end node 102A waits to receive either a confirmation of the completion of the reservations along the backup route or a notification of a failure to complete those reservations. The steps of this waiting are illustrated in FIG. 4. Where a No Resource Notification message is received (step 402) the head end node 102A sends a Label Abort Request message (step 404) on the backup route where the Label Abort Request message is processed by those nodes in the backup route up to the node that issued the No Resource Notification message. The head end node 102A can then indicate (step 406) to a network administrator the failure to reserve the requested protection bandwidth. Alternatively, the head end node 102A may select an alternate backup route and continue on from step 212 of FIG. 2. If, rather than a No Resource Notification message, the head end node 102A receives a Label Mapping Request message (step 408) the requested protection bandwidth has been successfully reserved along the backup route.

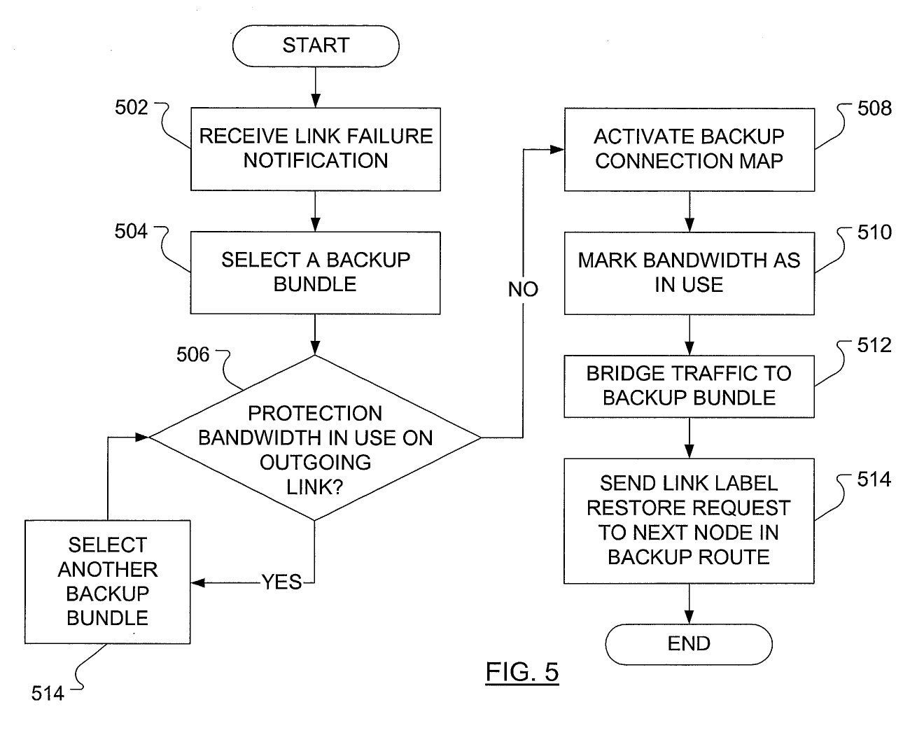

With protection bandwidth successfully reserved on the backup route and traffic flowing over the working link, the head end node 102A may receive a link failure notification (step 502, FIG. 5). Alternatively, the head end node 102A may receive a Manual Switch message. It may be that for the particular link between the head end node 102A and the tail end node 102B, more than one label switched paths have been established as backup routes. In such a case, the head end node 102A may have to select a backup bundle (step 504). This selection may be based on optimizing a metric that characterizes the backup bundle. The head end node 102A may then determine whether the protection bandwidth is in use on the first outgoing link (step 506). If the protection bandwidth is not in use on the first outgoing link, then the head end node 102A may activate the backup connection map (step 508). The head end node 102A may then mark the protection bandwidth on the first outgoing link as being used (step 510). The marking of this protection bandwidth as being used may include information such as an identification of the backup bundle using the protection bandwidth and an indication of the priority of the traffic. The interrupted traffic may then be bridged to the backup bundle (step 512). Finally, the head end node 102A sends a Link Label Restore Request message to the first node 102C on the backup route (step 514).

As will be apparent to a person skilled in the art, the indication of the traffic priority can be useful if a feature is later provided to such a system wherein one interrupted traffic flow may, by virtue of a higher priority, pre-empt another traffic flow from a given backup bundle.

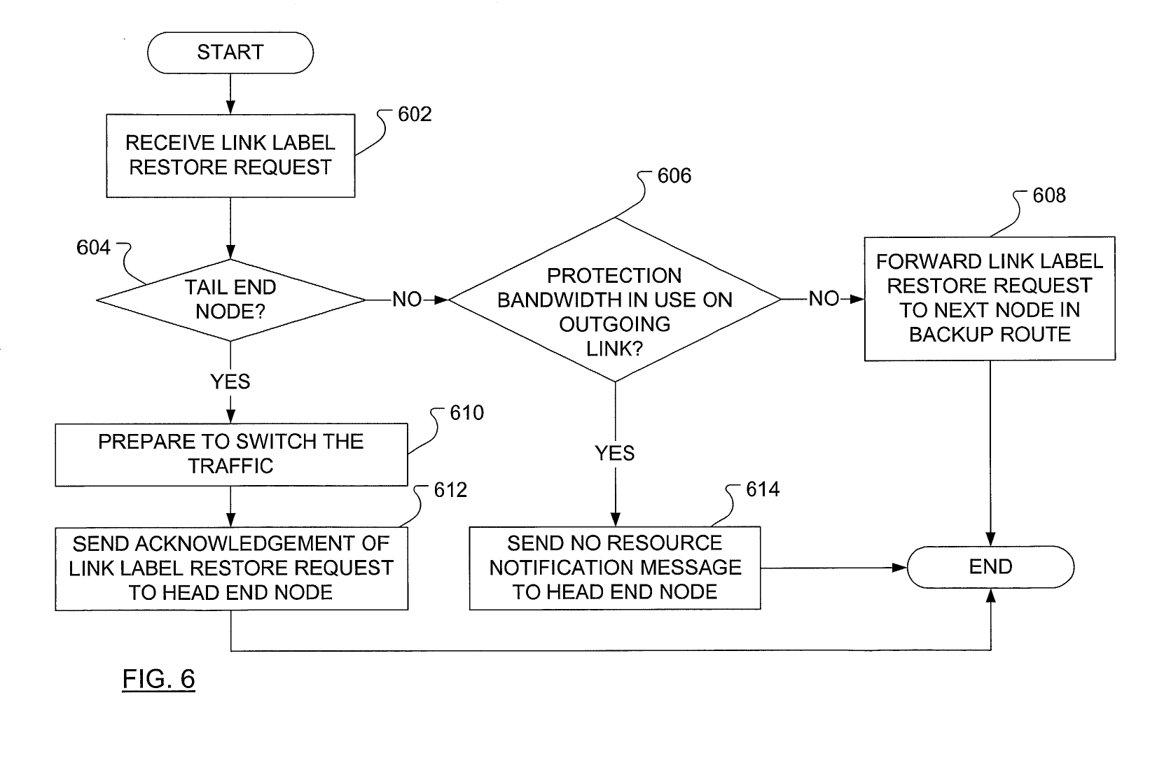

FIG. 6 illustrates the steps performed by a node along the backup route, which is not the head end node 102A, in response to the switching of traffic at the head end node 102A. Triggered by receiving a Link Label Restore Request message (step 602), and if the node is not the tail end node 102B (step 604), the node determines whether the reserved protection bandwidth on the outgoing link to the next node in the backup route is in use (step 606). If the node determines that the protection bandwidth is not in use, the node forwards the Link Label Restore Request message (step 608) to the next node in the backup route. If the node determines that the protection bandwidth is in use, the node sends a No Resource Notification message to the head end node 102A (step 614). Notably, a node along the backup route will not attempt to select an alternative backup route for an intermediate link (i.e., not the first fiber 104AC) if the bandwidth is not available. However, the network may be provisioned such that, if the traffic that is being protected is determined to have a higher priority than the traffic using the protection bandwidth, the traffic that is being protected may pre-empt the traffic using the protection bandwidth.

When the tail end node 102B receives the Link Label Restore Request message, the tail end node 102B switches the traffic incoming from the backup route (step 610) to the next node in the original connection. The tail end node 102B also sends an acknowledgement of the Link Label Restore Request message (step 612) to the head end node 102A along the backup route.

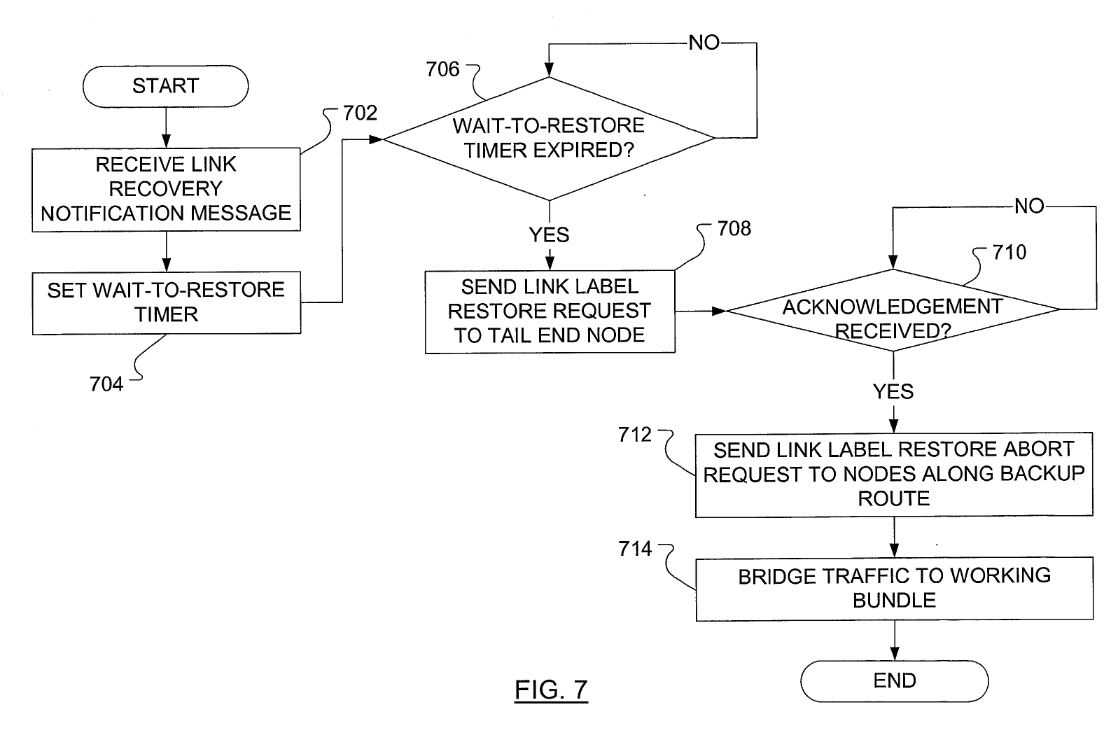

On receipt of this acknowledgement, the head end node 102A begins sending traffic over the backup route. With traffic flowing over the backup route, the head end node 102A may receive a Link Recovery Notification message (step 702, FIG. 7). Responsive to receiving this message, the head end node 102A may set a Wait-to-Restore timer (step 704) and monitor this Wait-to-Restore timer for expiration (step 706). Upon expiration of the Wait-to-Restore timer, the head end node 102A may send a Link Label Restore Request message (step 708) over the recovered fiber 104AB to the tail end node 102B. The head end node 102A then waits (step 710) for an acknowledgement that the Link Label Restore Request message has been received by the tail end node 102B. Upon receipt of such acknowledgement, the head end node 102A may send a Link Label Restore Abort Request message (step 712) to the nodes along the backup route. Finally, the head end node 102A may bridge the traffic (step 714) from the backup bundle to the now-working bundle on the recovered fiber 104AB.

Several considerations may be taken into account when designing a system to use the herein proposed mesh protection methods. For instance, the backup bandwidth on the path segments of backup LSPs is reserved, but may be shared among other backup bundles. The number of backup bundles sharing a given link may be configurable. Further, a connection request for which no backup resource is available may be flagged. The connection setup protocol can either reject the request or complete it with a warning to the operator. Additionally, the mesh protection may support revertive switching and there may be an option to set a limit on the number of hops in the backup route and the maximum cost (customer defined) that the backup route can have. Note that under revertive switching, the connection will be switched back from the backup LSP to the working link once the working link has cleared the failure that caused the switchover, and a provisioned wait to restore period has timed out. There may also be an option to set the number of alternative backup routes to be provided, but this number may be within a reasonable range.

As will be appreciated by a person skilled in the art, messages in this link redial signaling protocol, along with other traffic routing protocols mentioned above, may be sent and received in-band or out-of-band. When using in-band signaling, only the individual nodes 102 are involved with the restoration activities. When using out-of-band signaling, an Automatically Switched Optical Network (ASON) node (i.e., an optical router) may assist in coordinating the restoration activities. If via in-band signaling, the fault notification is done within the node 102 as is done for SONET. If via out-of-band, the fault notification will drive from the node 102 detected the link failure to the ASON node. A manual switch from working bundle to backup bundle is contemplated as being received as a manual command via user interface.

Other modifications will be apparent to those skilled in the art and, therefore, the invention is defined in the claims.

We claim:

1. A method of providing a link-redial service comprising:
receiving a request to set up a label switched path segment over a direct connection between a head end node and a tail end node, said request specifying a required protection bandwidth for said label switched path segment;
determining a backup route to said tail end node, responsive to said receiving, where said backup route avoids use of said direct connection between said head end node and said tail end node;
signaling to reserve said required protection bandwidth along said backup route;
receiving confirmation of reservation of said required protection bandwidth; and
generating a backup connection map, where said backup connection map associates a label related to said label switched path segment with an initial link in said backup route.

2. The method of claim 1 further comprising:
responsive to said receiving said request, signaling to establish said label switched path segment over said direct connection;
generating a working connection map, where said working connection map associates a label related to said label switched path segment with said direct connection; and
switching incoming traffic according to said working connection map.

3. The method of claim 2 further comprising:
receiving a link failure notification for said direct connection; and
responsive to said receiving said link failure notification, switching incoming traffic according to said backup connection map.

4. The method of claim 3 further comprising:
before said switching incoming traffic according to said backup connection map, selecting a backup bundle, where a backup bundle is a logical association of backup label switched paths that follow a single predetermined route to said tail end node;
determining whether protection bandwidth is in use on said selected backup bundle; and
where said protection bandwidth is not in use on said selected backup bundle, activating a backup connection map corresponding to use of said backup bundle.

5. The method of claim 4 further comprising, where said protection bandwidth is not in use on said selected backup bundle, marking said protection bandwidth as being a used.

6. The method of claim 5 wherein said marking includes an identification of said selected backup bundle.

7. The method of claim 5 wherein said marking includes an indication of a priority of traffic associated with said backup bundle.

8. A head end node in a mesh network comprising:
a plurality of input ports;
a plurality of output ports;
a connection processor adapted to connect selected ones of said plurality of input ports to selected ones of said plurality of output ports according to a working connection map, said connection processor operable to:
receive a request to set up a label switched path segment over a direct connection between said head end node and a tail end node, said request specifying a required protection bandwidth for said label switched path segment;
determine a backup route to said tail end node, responsive to said receiving, where said backup route avoids use of said direct connection between said head end node and said tail end node;
signal to reserve said required protection bandwidth along said backup route;
receive confirmation of reservation of said required protection bandwidth; and
generate a backup connection map, where said backup connection map associates a label related to said label switched path segment with an initial link in said backup route.

9. A head end node in a mesh network comprising:
means for receiving a request to set up a label switched path segment over a direct connection between a head end node and a tail end node, said request specifying a required protection bandwidth for said label switched path segment;
means for determining a backup route to said tail end node, responsive to said receiving, where said backup route avoids use of said direct connection between said head end node and said tail end node;
means for signaling to reserve said required protection bandwidth along said backup route;
means for receiving confirmation of reservation of said required protection bandwidth; and
means for generating a backup connection map, where said backup connection map associates a label related to said label switched path segment with an initial link in said backup route.

10. A computer readable medium containing computer-executable instructions which, when performed by a connection processor in a head end node in a communications network, cause the connection processor to:
receive a request to set up a label switched path segment over a direct connection between said head end node and a tail end node, said request specifying a required protection bandwidth for said label switched path segment;
determine a backup route to said tail end node, responsive to said receiving, where said backup route avoids use of said direct connection between said head end node and said tail end node;
signal to reserve said required protection bandwidth along said backup route;
receive confirmation of reservation of said required protection bandwidth; and
generate a backup connection map, where said backup connection map associates a label related to said label switched path segment with an initial link in said backup route.
